(19) United States
(12) Patent Application Publication
(10) Pub. No.: US 2010/0182624 A1
(43) Pub. Date: Jul. 22, 2010

(54) IMAGE FORMING APPARATUS AND IMAGE FORMING METHOD

(75) Inventor: Toshihiko Murakami, Kanagawa-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/690,599

(22) Filed: Jan. 20, 2010

Related U.S. Application Data
(60) Provisional application No. 61/146,023, filed on Jan. 21, 2009.

(51) Int. Cl. G06F 15/00

(52) U.S. Cl. 358/1.9; 358/1.15

(57) ABSTRACT

An image forming method includes receiving a private print job with a password and related information, acquiring, as reception date and time, date and time, storing the password, the related information, and the reception date and time in a private print job data base, editing and displaying information related to the print job, selecting at least one private print job, and printing the selected private print job, wherein the editing and displaying information related to at least one private print job includes classifying, on the basis of job priority time, private print jobs into a new job group and an old job group, and changing display order to display jobs belonging to the new job group in order from one having the earliest reception date and time and subsequently display jobs belonging to the old job group in order from one having the latest reception date and time.

### CROSS-REFERENCE TO RELATED APPLICATION

This application is based upon and claims the benefit of U.S. Provisional Application No. 61/146,023 filed on Jan. 21, 2009.

### TECHNICAL FIELD

Described herein relates to an image forming apparatus and an image forming method, and, more particularly to an image forming apparatus and an image forming method for receiving and printing a print job, print content of which is a confidential document.

### BACKGROUND

When a PC (Personal Computer) as a client apparatus transmits a private print job to an MFP (Multi Function Peripheral) as a printer, the MFP executes private print operation. Private print is a technique for performing print output by inputting an output request from an input unit annexed to the MFP without immediately outputting a received print job. With this private print function, it is possible to prevent a situation in which a confidential document is peeped or stolen by others.

In a technique disclosed in JP-A-2004-224058, a printing apparatus manages a print job with a password, which is transmitted from a host apparatus, together with a normal print job that does not require a password. When a user inputs an instruction from a control panel annexed to the printing apparatus, the printing apparatus displays a list of jobs managed as private print. When the user selects a job of the user from the displayed job list, the printing apparatus displays a password input request. When the user inputs an appropriate password, the printing apparatus starts job print.

In recent years, there is a growing need for information protection and, at the same time, there are an increasing number of cases in which the private print is used. Therefore, a printing apparatus is required to have the private print function as a standard function. However, when the number of cases of the private print increases and registrations of print jobs are concentrated, registered jobs cannot be displayed on one screen of a panel because of limitation on the size of a display screen. The user needs to search for a desired job by turning over pages on the screen or scrolling the pages. Therefore, there is a demand for simple search for a desired job.

### SUMMARY

Described herein relates to an image forming apparatus including: a receiving unit configured to receive a private print job with a password and related information through a network; a date-and-time acquiring unit configured to acquire, as reception date and time, date and time when the print job is received; a storing unit configured to store the password, the related information, and the reception date and time in a private print job data base; an editing and displaying unit configured to edit and display information related to at least one private print job stored in the private print job data base; a selecting unit configured to select at least one private print job displayed; and a printing unit configured to print the selected private print job when a password input by a user coincides with the password, wherein the editing and displaying unit includes: a classifying unit configured to classify, on the basis of job priority time that represents an elapsed time reference value from job reception date and time set in advance, private print jobs into a new job group and an old job group; and a display-order changing unit configured to change display order to display jobs belonging to the new job group in order from one having earliest reception date and time and subsequently display jobs belonging to the old job group in order from one having latest reception date and time.

Described herein relates to an image forming method including: receiving a private print job with a password and related information through a network; acquiring, as reception date and time, date and time when the print job is received; storing the password, the related information, and the reception date and time in a private print job data base; editing and displaying information related to at least one private print job stored in the private print job data base; selecting at least one private print job displayed; and printing the selected private print job when a password input by a user coincides with the password, wherein the editing and displaying information related to at least one private print job includes: classifying, on the basis of job priority time that represents an elapsed time reference value from job reception date and time set in advance, private print jobs into a new job group and an old job group; and changing display order to display jobs belonging to the new job group in order from one having the earliest reception date and time and subsequently display jobs belonging to the old job group in order from one having the latest reception date and time.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram of a network configuration according to a first embodiment of the present invention;

FIG. 2 is a block diagram of the main part configuration of an MFP;

FIG. 3 is an external view of a control panel provided in the MFP;

FIG. 4 is a diagram of a printing screen of a printer driver;

FIG. 5 is a diagram of a property screen;

FIG. 6 is a diagram of a password input screen;

FIG. 7 is a flowchart for explaining processing executed by a CPU when a print job is received;

FIG. 8 is a diagram of contents of a print job database;

FIG. 9 is a diagram of a job status screen;

FIG. 10 is a flowchart for explaining operation for editing a list of private print jobs placed in a queued state;

FIG. 11 is a diagram of a private print job screen;

FIG. 12 is a flowchart for explaining operation according to a second embodiment of the present invention for editing a list of private print jobs placed in a queued state;

FIG. 13 is a flowchart for explaining operation according to a third embodiment of the present invention for editing a list of private print jobs placed in a queued state; and

FIG. 14 is a flowchart for explaining a procedure for processing a schedule print job.

### DETAILED DESCRIPTION

### First Embodiment

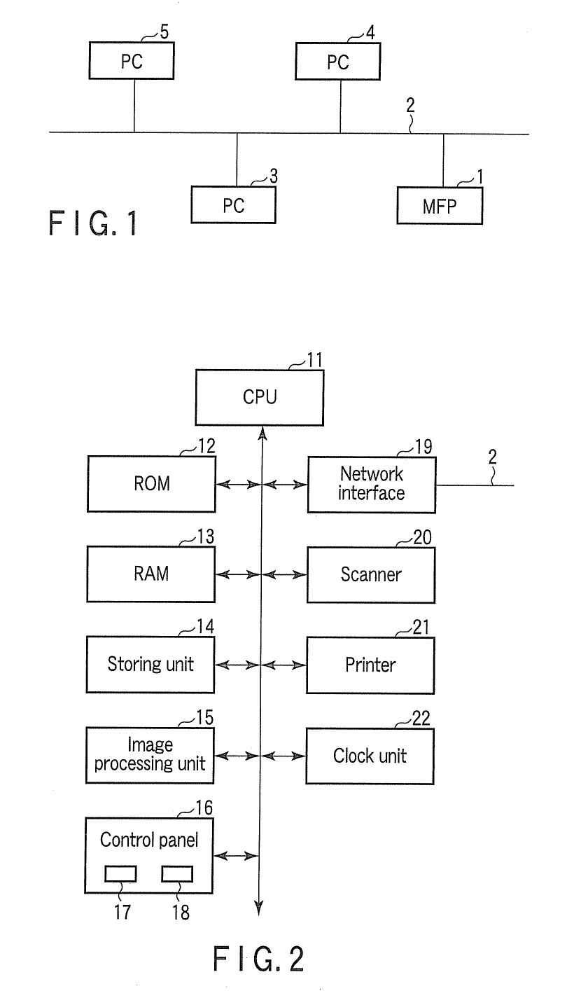

FIG. 1 is a schematic diagram of a network configuration according to a first embodiment of the present invention. A multi function peripheral (hereinafter referred to as MFP) 1 is connected to personal computers (PCs) 3, 4, and 5 through a network 2. The PCs 3, 4, and 5 are computers of an administrator who manages apparatuses connected to the network 2.

FIG. 2 is a block diagram of the main part configuration of the MFP 1. The MFP 1 includes a CPU 11, a ROM 12, a RAM 13, a storing unit 14, an image processing unit 15, a control panel 16, a network interface 19, a scanner 20, a printer 21, and a clock unit 22. The CPU 11 is connected to the ROM 12, the RAM 13, the storing unit 14, the image processing unit 15, the control panel 16, the network interface 19, the scanner 20, the printer 21, and the clock unit 22 via a bus line.

The CPU 11 controls the entire MFP 1 by executing a control program stored in the ROM 12. The ROM 12 has stored therein the control program executed by the CPU 11 and fixed data. The RAM 13 has a work area or the like that is necessary when the CPU 11 executes the control program stored in the ROM 12.

The storing unit 14 is, for example, a hard disk drive. The storing unit 14 stores various data such as image data and print job data and also stores various computer programs. The image processing unit 15 applies processing such as compression and expansion to the image data. The control panel 16 includes an operation unit 17 and a display unit 18. The operation unit 17 passes an instruction received from a user to the CPU 11. The display unit 18 displays information necessary for the user under the control by the CPU 11.

The network interface 19 is connected to the network 2 and performs data communication with the PCs 3, 4, and 5 connected to the network 2. The scanner 20 reads an image from an original document placed on a not-shown document table or an original document fed by a not-shown auto document feeder and generates image data. The printer 21 forms an image on a sheet on the basis of a print job received through the network 2 or image data read out from the storing unit 14 and subjected to expansion processing by the image processing unit 15. The clock unit 22 generates date and time information. The CPU 11 acquires, when necessary, the date and time information generated by the clock unit 22.

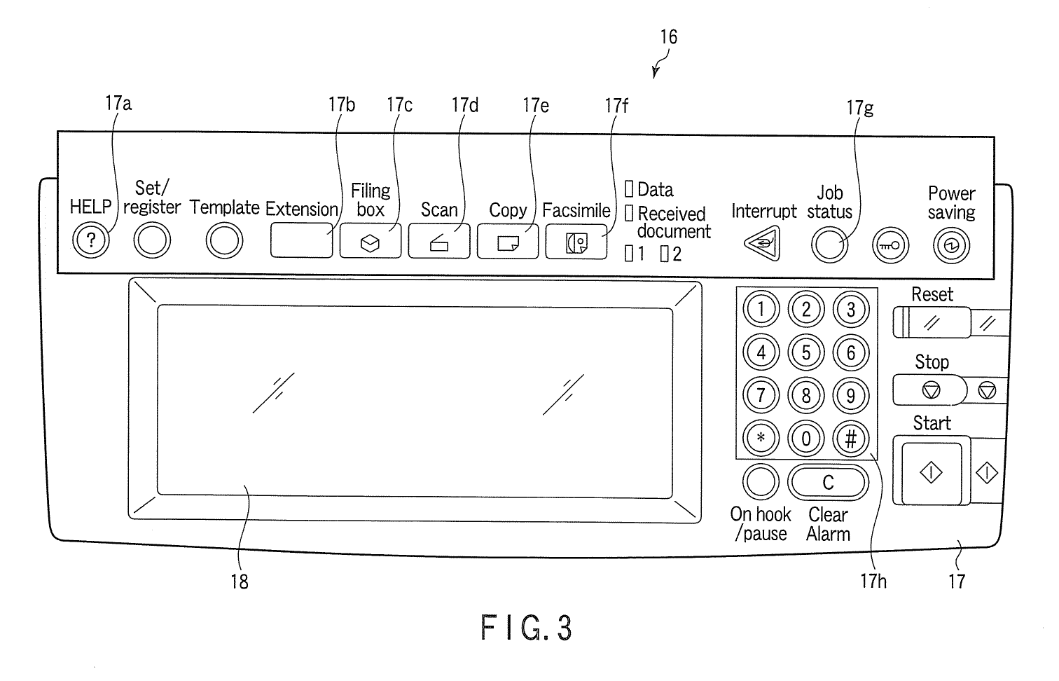

FIG. 3 is an external view of the control panel 16 provided in the NFP 1. The user performs setting and check of the MFP 1 via the control panel 16. The control panel 16 includes the display unit 18 and the operation unit 17. The display unit 18 includes a touch panel and displays a state of the MFP 1, an operation procedure, various instructions given to the user, and the like. The operation unit 17 includes various operation buttons for operating the MFP 1.

As keys for invoking a screen for selecting and setting functions, a help button 17a, a function extension button 17b, a filing box button 17c, a scan button 17d, a copy button 17e, a facsimile button 17f, a state check button 17g, and the like are arranged in the operation unit 17. Besides, a ten key 17h and the like for inputting a set value and checking information are also arranged.

Functions of main buttons among these operation buttons are explained below. The help button 17a is used to inquire, for example, what kind of operation should be performed next. The extension button 17b is operated to use an extended function. The filing box button 17c is used to extract stored image data. The scan button 17d is used to use a scan function. The copy button 17e is used to use a copy function. The facsimile button 17f is used to use a facsimile function. The state check button 17g is used to execute private print. The ten key 17h is used to input numbers.

Private print operation is explained below.

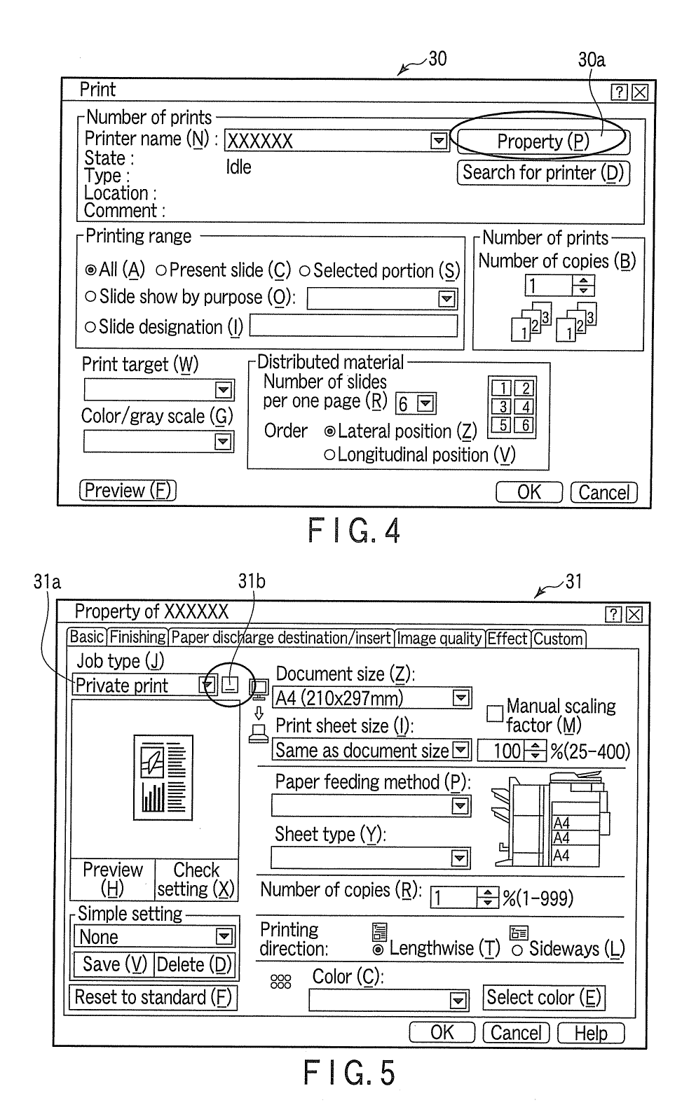

When the user attempts to execute private print using the PC 3, the user starts a printer driver after editing a print job. FIG. 4 is a printing screen 30 of the printer driver.

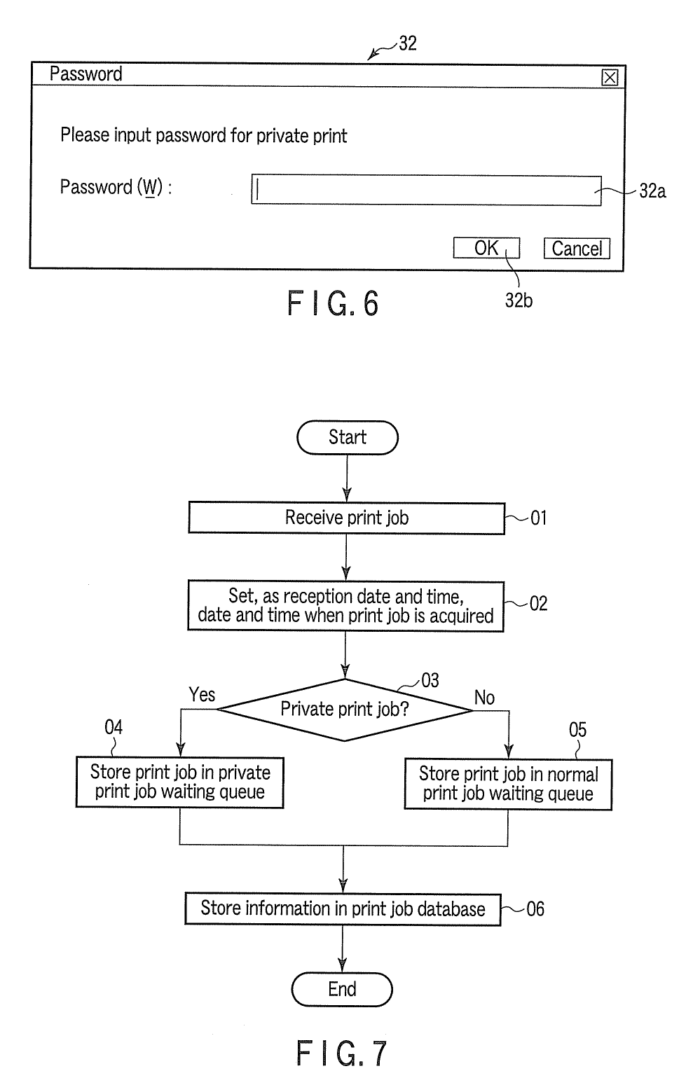

When the user presses a property button 30a of the printing screen 30, a property screen 31 shown in FIG. 5 is displayed. When the user selects “private print” from a pull-down menu, inputs “private print” to a job type input space 31a, and operates a setting button 31b, a password input screen 32 shown in FIG. 6 is displayed.

The user can set a password for a private print job by inputting the password to a password input space 32a and operating an OK button 32b. The password set for the private print job is used for authentication for permitting the user to perform operation concerning private print in the MFP 1. Therefore, the user can arbitrarily set the password.

When the user operates the OK button 32b after setting other printing functions of the screen shown in FIGS. 4 and 5, a user name (a user ID) and the like allocated to the PC 3 are transmitted to the MFP 1 besides print job data, a print job name, a job type (private print), and the password. Processing same as the processing explained above is performed in the PCs 4 and 5.

Processing executed when the MFP 1 receives a print job from any one of the PCs 3, 4, and 5 through the network 2 is explained below. FIG. 7 is a flowchart for explaining processing executed by the CPU 11 when the CPU 11 receives a print job.

When the CPU 11 receives a print job in Act 01, in Act 02, the CPU 11 acquires date and time information generated by the clock unit 22 and sets the date and time information as print job reception date and time. Subsequently, in Act 03, the CPU 11 checks whether a job type of the print job is private print.

In the case of Yes in Act 03, i.e., if the job type is the private print, in Act 04, the CPU 11 expands PDL data of the received print job into a bit-mapped image, executes various kinds of image processing, and then stores the bit-mapped image in a private print job waiting queue. In the case of No in Act 03, i.e., if the job type is not the private print, in Act 05, the CPU 11 expands the PDL data of the received print job into a bit-mapped image, executes various kinds of image processing, and then stores the bit-mapped image in a normal print job waiting queue.

After storing the print job in the private print job waiting queue or the normal print job waiting queue, in Act 06, the CPU 11 stores the information in a print job database D1 provided in the storing unit 14.

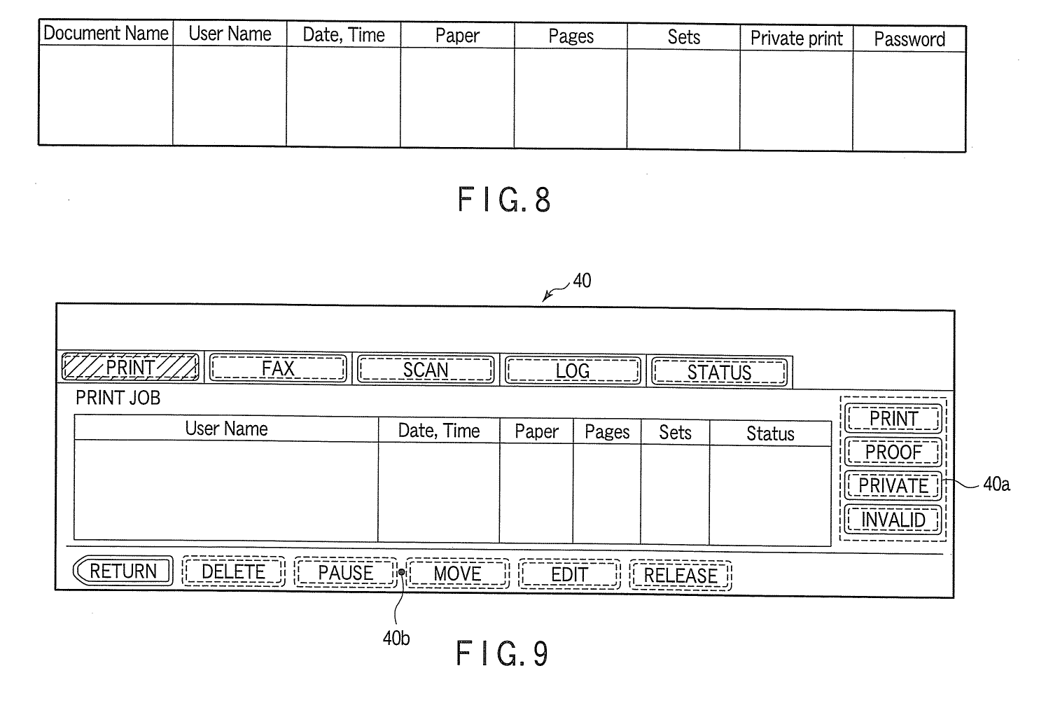

FIG. 8 is a diagram of contents of the print job database D1. The print job database D1 includes, as items, “document name”, “user name”, “date, time”, “paper”, “pages”, “sets”, “private print”, and “password”.

The items “document name” and “user name” of the print job database D1 are respectively “print job name” and “user name” transmitted from the PC 3. When a print job is stored in the private print job waiting queue, “YES” is stored in the “private print”. When a print job is stored in the normal print job waiting queue, “NO” is stored in the “private print”.

The print job database D1 includes, as a common item applied to the private print, “job priority time”. A method of using the “job priority time” is explained later.

The private print operation of the MFP 1 is explained. After transmitting print data, the user moves to a place where the MFP 1 is set and selects the “private print” from the control panel 16.

First, the user operates the state check button 17g of the control panel 16 shown in FIG. 3. A job status screen 40 shown in FIG. 9 is displayed on the display unit 18. When the user selects a tab “PRINT, “FAX”, or “SCAN” displayed on the job status screen 40, a list of jobs corresponding to the tab placed in a queued state is displayed.

When the user selects the tab “PRINT” and further selects “private” in a job type selection button 40a, the CPU 11 displays a list of private print jobs placed in a queued state. Content of an operation button 40b changes according a selection result of the job type selection button 40a.

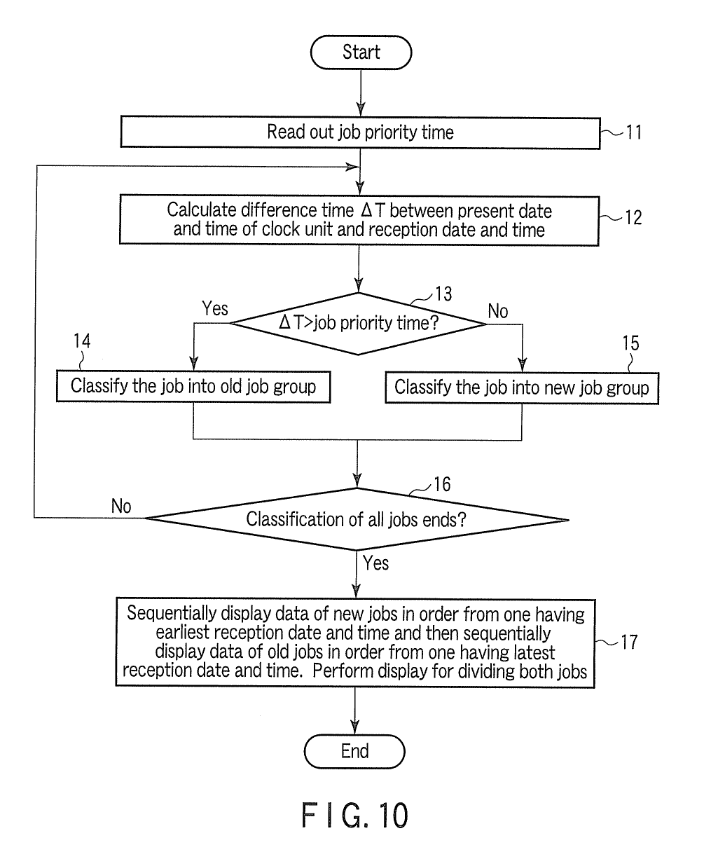

FIG. 10 is a flowchart for explaining operation for editing the list of the private print jobs placed in the queued state.

In Act 11, the CPU 11 reads out the “job priority time” of the print job database D1. The “job priority time” is explained. In this embodiment, jobs in a queue are classified into a new job group and an old job group with reference to the “job priority time”. The user can set a value of the “job priority time” from the control panel 16.

In Act 12, the CPU 11 extracts one of the private print jobs in a queue in the print job database D1 and calculates difference time ΔT between the item “data, time” and date and time information of the clock unit 22.

In Act 13, the CPU 11 compares the job priority time and the difference time ΔT. In the case of Yes in Act 13, i.e., if time longer than the job priority time elapses after a job is transmitted, in Act 14, the CPU 11 classifies the job into the old job group. In the case of No in Act 13, i.e., if the job priority time does not elapse after the job is transmitted, in Act 15, the CPU 11 classifies the job into the new job group.

In Act 16, the CPU 11 checks whether the classification processing is carried out for all target private print jobs. If there is an unprocessed job, the CPU 11 executes the processing from Act 12. If the classification processing is finished for all the jobs, the CPU 11 executes display processing on the basis of a classification result.

In Act 17, the CPU 11 sequentially displays data of the new jobs in order from data having the earliest reception date and time. Subsequently, the CPU 11 sequentially displays data of the old jobs in order from one having the latest reception date and time. The CPU 11 performs display for dividing both the jobs.

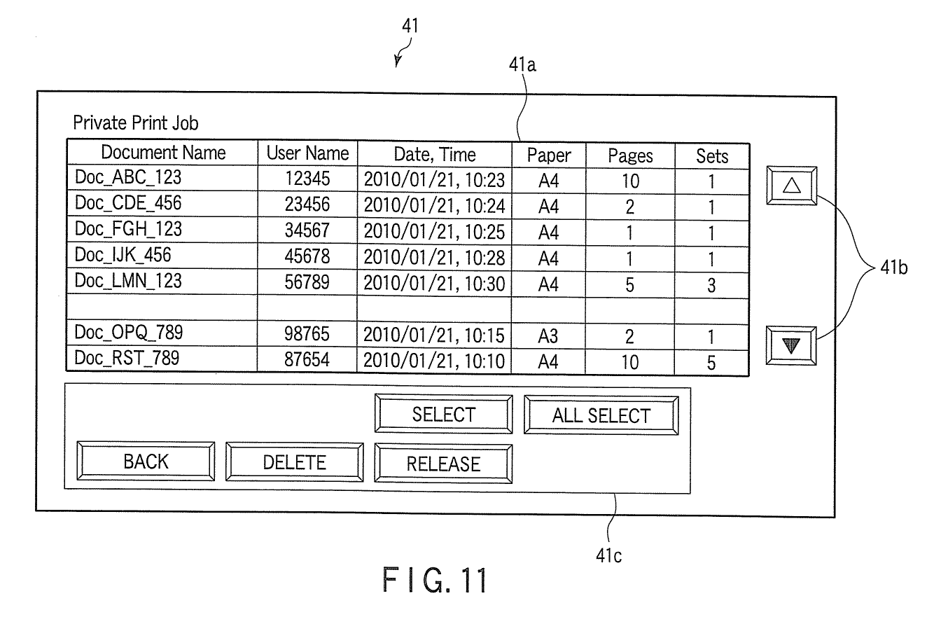

FIG. 11 is a diagram of a private print job screen 41. The private print job screen 41 includes a queued job list display area 41a, a scroll button 41b, and an operation button area 41c.

Five jobs classified into the new job group are displayed in the queued job list display area 41a in order from one having the earliest reception date and time. Following a blank row, jobs classified into the old job group are displayed in order from one having the latest reception date and time.

Blank row display is display serving as a delimiter between the new job group and the old job group. A purpose of the blank row display is to facilitate the user to distinguish and grasp the two groups. Therefore, instead of the blank row, a frame line in a boundary of the groups may be displayed thick, a color of characters may be changed for each of the groups, or a background color may be changed for each of the groups.

The number of jobs that can be displayed in the queued job list display area 41a is limited by the size of a screen. The user can check all the queued jobs by operating the scroll button 41b.

The user can select a job by touching a position where the job is displayed on the queued job list display area 41a. The selected job is reversely displayed. After selecting at least one job, the user operates a “SELECT” button of the operation button area 41c to decide the selected job. When the user operates a “RELEASE” button in this state, a password input screen is displayed.

When the user inputs a password, it is checked whether the password coincides with a password corresponding to the selected job. When the password coincides with the password corresponding to the selected job, the selected private print job is sent to the normal print job waiting queue and printing is started.

Usually, after transmitting the private print job from the PC to the MFP 1, the user moves to a place where the MFP 1 is set and executes operation for printing without delay. In that case, the transmitted job is classified into the new job group on the private print job screen 41 and displayed on a first display screen. Therefore, the user does not need to perform operation for searching for a job.

As explained above, in this embodiment, even when a large number of jobs are held up in the job waiting queue in the private print, operability for the user who attempts to print a job anew is not deteriorated.

### Second Embodiment

In a second embodiment of the present invention, a method of classifying a new job group and an old job group is different from that in the first embodiment. Therefore, components same as those in the first embodiment are denoted by the same reference numerals and signs and detailed explanation of the components is omitted.

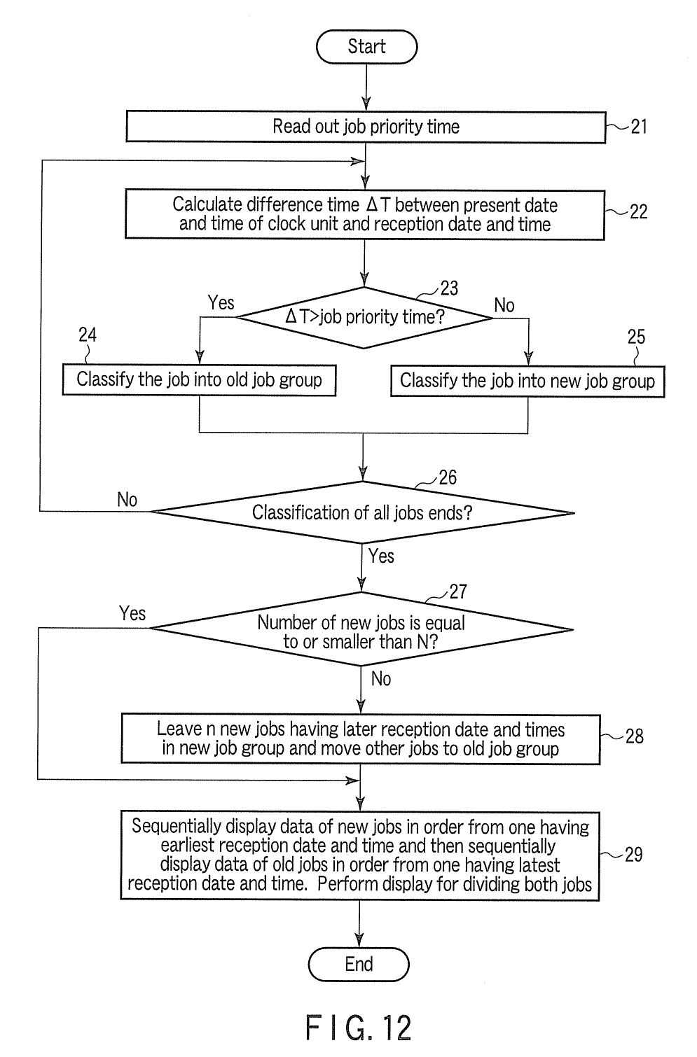

FIG. 12 is a flowchart for explaining operation according to the second embodiment for editing a list of private print jobs placed in a queued state.

In Act 21, the CPU 11 reads out the “job priority time” of the print job database D1.

In Act 22, the CPU 11 extracts one private print job in a queue in the print job database D1 and calculates a difference time ΔT between the item “reception date and time” and the date and time information of the clock unit 22.

In Act 23, the CPU 11 compares the job priority time and the difference time ΔT. In the case of Yes in Act 23, i.e., if time longer than the job priority time elapses after a job is transmitted, in Act 24, the CPU 11 classifies the job into the old job group. In the case of No in Act 23, i.e., if the job priority time does not elapse after the job is transmitted, in Act 25, the CPU 11 classifies the job into the new job group.

In Act 26, the CPU 11 checks whether the classification processing is carried out for all target private print jobs. When there in an unprocessed job, the CPU 11 executes the processing from Act 22. When the classification processing is finished for all the jobs, the CPU 11 executes processing in Act 27.

In Act 27, the CPU 11 checks whether the number of jobs classified into the new job group is equal to or smaller than a predetermined number n. In the case of No in Act 27, i.e., if the number of jobs classified into the new job group is larger than the predetermined number n, in Act 28, the CPU 11 leaves n jobs having later reception date and times among the new jobs in the new job group and moves the other jobs to the old job group. “n” is a number equal to or smaller than a maximum number of jobs that can be displayed on one screen in the private print job screen 41.

In Act 29, the CPU 11 sequentially displays data of the new jobs in order from one having the earliest date and time and then displays data of the old jobs in order from one having the latest reception date and time. The CPU 11 performs display for dividing both the jobs.

In the second embodiment, in addition to the effects of the first embodiment, since the number of jobs belonging to the new job group can be set to n at the maximum, a transmitted job is displayed on a first display screen in the private print job screen 41. Therefore, a user does not need to perform operation for searching for a job.

### Third Embodiment

In a third embodiment of the present invention, a method of classifying a new job group and an old job group is different from that in the first embodiment. Therefore, components same as those in the first embodiment are denoted by the same reference numerals and signs and detailed explanation of the components is omitted.

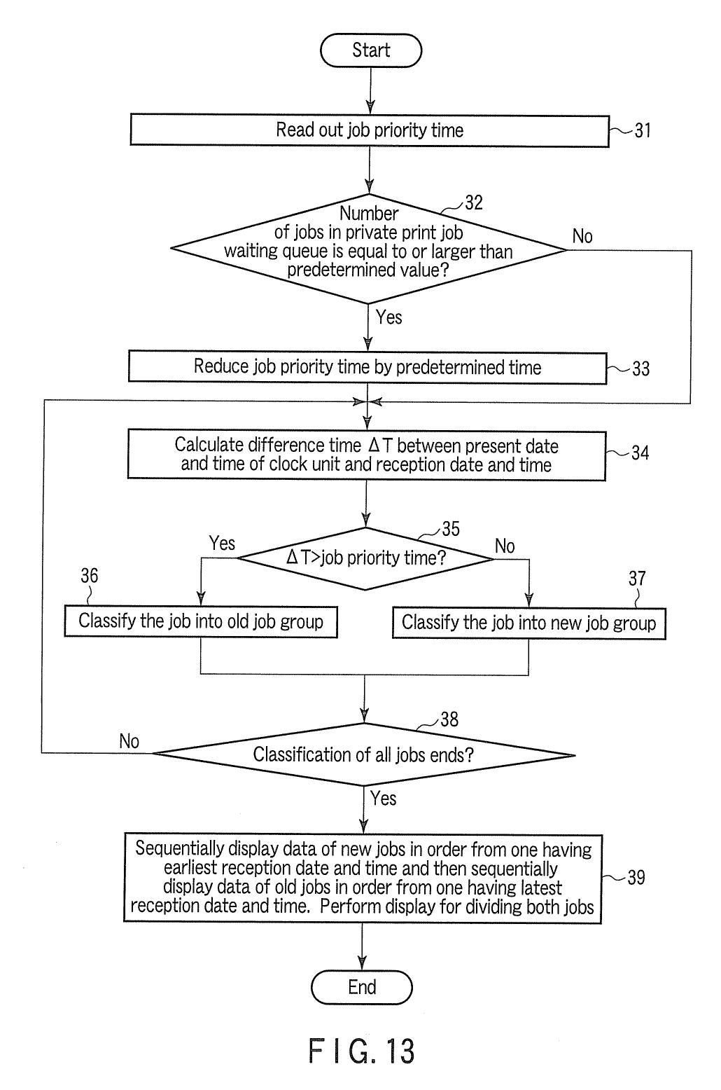

FIG. 13 is a flowchart for explaining operation according to the third embodiment for editing a list of private print jobs placed in a queued state.

In Act 31, the CPU 11 reads out the “job priority time” of the print job database D1. In Act 32, the CPU 11 extracts the number of private print jobs in a queue in the print job database D1. The number of private print jobs is equivalent to the number of jobs stored in the private print job waiting queue. The CPU 11 checks whether the number is equal to or larger than a predetermined value P1.

In the case of Yes in Act 32, i.e., if the number of jobs in a queue is equal to or larger than the predetermined value P1, in Act 33, the CPU 11 reduces the “job priority time” by a predetermined time T. In the case of No in Act 32, i.e., if the number of jobs in a queue is smaller than the predetermined value P1, the CPU 11 keeps the “job priority time”. A user can set the “job priority time”, the “predetermined time T”, and the “predetermined value P1” from the control panel 16.

In Act 34, the CPU 11 extracts one private print job in a queue in the print job database D1 and calculate a difference time ΔT between the item “reception date and time” and date and time information of the clock unit 22.

In Act 35, the CPU 11 compares the job priority time and the difference time ΔT. In the case of Yes in Act 35, i.e., if time longer than the job priority time elapses after a job is transmitted, in Act 36, the CPU 11 classifies the job into the old job group. In the case of No in Act 35, i.e., if the job priority time does not elapse after the job is transmitted, in Act 37, the CPU 11 classifies the job into the new job group.

In Act 38, the CPU 11 checks whether the classification processing is carried out for all target private print jobs. If there is an unprocessed job, the CPU 11 executes the processing from Act 34. If the classification processing is finished for all the jobs, the CPU 11 executes display processing on the basis of a classification result.

In Act 39, the CPU 11 sequentially displays data of the new jobs in order from one having the earliest reception date and time. Subsequently, the CPU 11 sequentially displays data of the old jobs in order from one having the latest reception date and time. The CPU 11 performs display for dividing both the jobs.

According to the third embodiment, even when a large number of jobs in a queue are present, since the “job priority time” is reduced, a job received by the MFP 1 most recently is displayed in first display screen display. Therefore, the user does not need to perform operation for searching for a job.

### Fourth Embodiment

In a fourth embodiment of the present invention, a display procedure for a job list table is different from that in the first embodiment. Therefore, components same as those in the first embodiment are denoted by the same reference numerals and signs and explanation of the components is omitted.

A user operates the state check button 17g of the control panel 16 shown in FIG. 3. The job status screen 40 shown in FIG. 9 is displayed on the display unit 18. When the user selects the tab “PRINT” and further selects “PRIVATE” in the job type selection button 40a, the CPU 11 displays a list of “user names” of users who register private print jobs.

The user selects a user name of the user and depresses the “RELEASE” button. Since a password input screen is displayed, the user inputs a password. Then, a private print job list of the user is displayed. The private print job list is displayed in the form explained in the first to third embodiments.

In the fourth embodiment, all user names of the private print job list displayed in the form explained in the first to third embodiments are the same. Therefore, it is possible to easily search for a desired job.

### Fifth Embodiment

A fifth embodiment of the present invention is different from the embodiments explained above in that the private print job in the first to fourth embodiments and a schedule print job are combined. Therefore, components same as those in the first to fourth embodiments are denoted by the same reference numerals and signs and explanation of the components is omitted.

The schedule print job is a technique for performing print output at designated date and time without immediately outputting a received print job. In the fifth embodiment, the schedule print job is treated in the private print job.

When a user presses the property button 30a shown in FIG. 4, the property screen 31 shown in FIG. 5 is displayed. The user selects “private print+schedule print” from a pull-down menu and inputs a job type in the job type input space 31a. After inputting a password and performing other settings, the user transmits information to the MFP 1.

In the MFP 1, the CPU 11 receives a print job and checks whether a schedule print job is included in the job type. When a schedule print job is included in the job type, even if the job type is private print and schedule print, the CPU 11 stores the transmitted job in the schedule print job waiting queue. The CPU 11 sets a timer in the clock unit 22 such that the timer starts in order to process the schedule print job at designated date and time. The CPU 11 stores information concerning a print job transmitted from a PC in the storing unit 14.

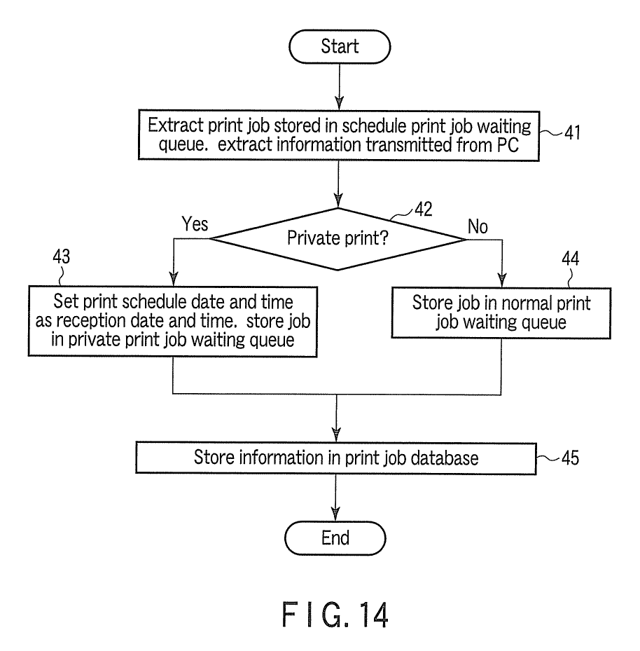

FIG. 14 is a flowchart for explaining a procedure for processing the schedule print job.

In Act 41, the CPU 11 extracts the print job stored in the schedule print job waiting queue at timing after the designated date and time. The CPU 11 extracts the information transmitted from the PC and stored in the storing unit 14.

In Act 42, the CPU 11 checks whether the private print is designated for the job. In the case of Yes in Act 42, i.e., if the private print is designated, in Act 43, after expanding PDL data of the extracted print job into a bit-mapped image and executing respective kinds of image processing, the CPU 11 stores the bit-mapped image in the private print job waiting queue. The CPU 11 sets the present date and time as reception date and time.

In the case of No in Act 42, i.e., if the private print is not designated, in Act 44, after expanding the PDL data of the extracted print job into a bit-mapped image and executing the respective kinds of image processing, the CPU 11 stores the bit-mapped image in the normal print job waiting queue.

After storing the print job in the private print job waiting queue or the normal print job waiting queue in this way, in Act 45, the CPU 11 stores the information in the print job database D1.

The following processing of the private print job is the same as the processing explained in the first to fourth embodiments. Therefore, detailed explanation of the processing is omitted.

According to the fifth embodiment, it is possible to process a job of the schedule print and the private print. If this function is used, for example, a user present at an A point can transmit a schedule print job to an MFP present at a remote B point, visit the B point at designated date and time, and perform private print at the B point.

As explained above, according to this embodiment, the user can easily search for a desired private print job without performing complicated display operation.

The present invention is explained above with reference to the specific embodiments. However, it would be obvious to those skilled in the art that various modifications and alterations are possible without departing from the spirit and the scope of the present invention.

For example, the print job and the information may be stored in the private print job waiting queue.

Therefore, it is possible to devise an invention by appropriately combining the inventions of the first to fifth embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a receiving unit configured to receive a private print job with a password and related information through a network;
a date-and-time acquiring unit configured to acquire, as reception date and time, date and time when the print job is received;
a storing unit configured to store the password, the related information, and the reception date and time in a private print job data base;
an editing and displaying unit configured to edit and display information related to at least one private print job stored in the private print job data base;
a selecting unit configured to select at least one private print job displayed; and
a printing unit configured to print the selected private print job when a password input by a user coincides with the password, wherein
the editing and displaying unit includes:
a classifying unit configured to classify, on the basis of job priority time that represents an elapsed time reference value from job reception date and time set in advance, private print jobs into a new job group and an old job group; and
a display-order changing unit configured to change display order to display jobs belonging to the new job group in order from one having earliest reception date and time and subsequently display jobs belonging to the old job group in order from one having latest reception date and time.

2. The apparatus according to claim 1, wherein
the related information includes a user ID for specifying the user, and
the editing and displaying unit edits and displays information related to the print job corresponding to the user ID selected by the user among print jobs stored in the private print job data base.

3. The apparatus according to claim 1, wherein
the receiving unit receives, through the network, a composite job of the private print job with the password and a schedule print job and information representing designated print date and time,
the date-and-time acquiring unit acquires, concerning the composite job, the designated print date and time as reception date and time, and
the apparatus further comprises a control unit configured to store after the designated print date and time, the password, the related information, and the reception date and time in the private print job data base with the composite job set as a private print job anew.

4. The apparatus according to claim 1, wherein the classifying unit classifies a job, from reception date and time of which the job priority time does not elapse, into the new job group and classifies a job, from reception date and time of which the job priority time elapses, into the old job group.

5. The apparatus according to claim 4, wherein
the related information includes a user ID for specifying the user, and
the editing and displaying unit edits and displays information related to the print job corresponding to the user ID selected by the user among print jobs stored in the private print job data base.

6. The apparatus according to claim 4, wherein
the receiving unit receives, through the network, a composite job of the private print job with the password and a schedule print job and information representing designated print date and time,
the date-and-time acquiring unit acquires, concerning the composite job, the designated print date and time as reception date and time, and
the apparatus further comprises a control unit configured to store after the designated print date and time, the password, the related information, and the reception date and time in the private print job data base with the composite job set as a private print job anew.

7. The apparatus according to claim 1, wherein the classifying unit classifies a job, from reception date and time of which the job priority time does not elapse, into the new job group and classifies a job, from reception date and time of which the job priority time elapses, into the old job group, and, when a number of jobs belonging to the new job group is larger than a predetermined number N, classifies N jobs having later reception date and times into the new job group and classifies the other jobs into the old job group.

8. The apparatus according to claim 7, wherein
the related information includes a user ID for specifying the user, and
the editing and displaying unit edits and displays information related to the print job corresponding to the user ID selected by the user among print jobs stored in the private print job data base.

9. The apparatus according to claim 7, wherein
the receiving unit receives, through the network, a composite job of the private print job with the password and a schedule print job and information representing designated print date and time,
the date-and-time acquiring unit acquires, concerning the composite job, the designated print date and time as reception date and time, and
the apparatus further comprises a control unit configured to store after the designated print date and time, the password, the related information, and the reception date and time in the private print job data base with the composite job set as a private print job anew.

10. The apparatus according to claim 1, further comprising a priority-time changing unit configured to reduce the job priority time when a number of private print jobs in a queue is larger than a predetermined number, wherein
the classifying unit classifies a job, from reception date and time of which the job priority time does not elapse, into the new job group and classifies a job, from reception date and time of which the job priority time elapses, into the old job group.

11. The apparatus according to claim 10, wherein
the related information includes a user ID for specifying the user, and
the editing and displaying unit edits and displays information related to the print job corresponding to the user ID selected by the user among print jobs stored in the private print job data base.

12. The apparatus according to claim 10, wherein
the receiving unit receives, through the network, a composite job of the private print job with the password and a schedule print job and information representing designated print date and time,
the date-and-time acquiring unit acquires, concerning the composite job, the designated print date and time as reception date and time, and
the apparatus further comprises a control unit configured to store after the designated print date and time, the password, the related information, and the reception date and time in the private print job data base with the composite job set as a private print job anew.

13. An image forming method comprising:
receiving a private print job with a password and related information through a network;
acquiring, as reception date and time, date and time when the print job is received;
storing the password, the related information, and the reception date and time in a private print job data base;
editing and displaying information related to at least one private print job stored in the private print job data base;
selecting at least one private print job displayed; and
printing the selected private print job when a password input by a user coincides with the password, wherein
the editing and displaying information related to at least one private print job includes:
classifying, on the basis of job priority time that represents an elapsed time reference value from job reception date and time set in advance, private print jobs into a new job group and an old job group; and
changing display order to display jobs belonging to the new job group in order from one having the earliest reception date and time and subsequently display jobs belonging to the old job group in order from one having the latest reception date and time.

14. The method according to claim 13, wherein the classifying the private print jobs includes classifying a job, from reception date and time of which the job priority time does not elapse, into the new job group and classifying a job, from reception date and time of which the job priority time elapses, into the old job group.

15. The method according to claim 13, wherein the classifying the private print jobs includes classifying a job, from reception date and time of which the job priority time does not elapse, into the new job group and classifying a job, from reception date and time of which the job priority time elapses, into the old job group, and, when a number of jobs belonging to the new job group is larger than a predetermined number N, classifying N jobs having later reception date and times into the new job group and classifying the other jobs into the old job group.

16. The method according to claim 13, further comprising reducing the job priority time when a number of private print jobs in a queue is larger than a predetermined number, wherein
the classifying the private print jobs includes classifying a job, from reception date and time of which the job priority time does not elapse, into the new job group and classifying a job, from reception date and time of which the job priority time elapses, into the old job group.

17. The method according to claim 13, wherein
the related information includes a user ID for specifying the user, and
the editing and displaying information related to the private print jobs includes editing and displaying a print job corresponding to the user ID selected by the user among print jobs stored in the private print job data base.

18. The method according to claim 13, further comprising:
receiving, through the network, a composite job of the private print job with the password and a schedule print job and information representing designated print date and time;
acquiring, concerning the composite job, the designated print date and time as reception date and time; and
storing after the designated print date and time, the password, the related information, and the reception date and time in the private print job data base with the composite job set as a private print job anew.
